(19) United States
(12) Patent Application Publication
(10) Pub. No.: US 2008/0114662 A1
(43) Pub. Date: May 15, 2008

(54) E-commerce system and method employing accumulative assembly of orders

(76) Inventor: Hanshi Nianmin Qi, Union City, CA (US)

Correspondence Address: Douglas E. Mackenzie, P.O. Box 1295, Mt. View, CA, 94042, US

(21) Appl. No.: 11/581,612

(22) Filed: Oct. 16, 2006

(51) Int. Cl. G06Q 30/00

(52) U.S. Cl. 705/26

(57) ABSTRACT

A method of selling goods is disclosed. The method includes initiating an accumulator having a set point, the set point reflecting an amount of goods to be shipped, the accumulator keeping track of buyer orders, soliciting buyer orders, and shipping the goods upon reaching the set point. An so associated system and software product is also disclosed.

### BACKGROUND OF THE INVENTION

The present invention relates generally to e-commerce and more particularly to an e-commerce system and method for ordering goods that employs accumulative assembly of orders to achieve economies of scale.

To facilitate electronic commerce (e-commerce) systems and methods for ordering and delivering goods over the Internet include the utilization of retailer websites from which buyers can select goods for retail purchase and delivery. Wholesaler websites are usually only accessible by customers able to buy in large quantities for resale, such customers conventionally being referred to as “middlemen”. Given these constraints, retail buyers must pay a retail price that is greater than a wholesale price for the same goods, the difference in cost including the added costs associated with retail distribution, transportation and warehousing of the goods.

There is therefore a need for a system and method that allows retail buyers to pay wholesale prices for goods. There is a further need for a system and method that allows both buyers and sellers of goods to initiate the sale of goods. There is also a need for a system and method that facilitates commercial transactions including the sale of goods between parties including exporters and importers, and buyers and sellers, over the Internet. There is an additional need for a system and method that employs accumulative assembly of orders to achieve economies of scale in the sale of goods.

### SUMMARY OF THE INVENTION

In one aspect of the invention, a method employs an accumulator that tracks the number of orders placed by buyers. The accumulator may be initiated by either a seller or sellers of goods or by a buyer or buyers with contacts with a seller or sellers. When the accumulator is initiated, a set point is set based upon a cost effective or scale effective quantity of the goods being sold. When the set point is reached, the goods are shipped by the seller or sellers. Buyers may participate in the accumulator by placing orders over the Internet.

In accordance with an aspect of the invention, a method of selling goods includes the steps of initiating an accumulator having a set point, the set point reflecting an amount of goods to be shipped, the accumulator keeping track of buyer orders; soliciting buyer orders; and while the set point is not reached, not shipping the goods, and when the set pint is reached, shipping the goods.

In accordance with another aspect of the invention, a system of selling goods includes an accumulator having a set point, the set point reflecting an amount of goods to be shipped, the accumulator keeping track of buyer orders and being implemented in a machine; and a means for soliciting buyer orders wherein while the set point is not reached, not shipping the goods, and when the set pint is reached, shipping the goods.

In accordance with another aspect of the invention, a machine executable sequence of process steps for selling includes a code segment operable to instruct a machine on a network to instantiate an accumulator having a set point, the set point reflecting an amount of goods to be shipped, the accumulator keeping track of buyer orders and being implemented in the machine; and a code segment operable to instruct the machine on the network to instantiate a means for soliciting buyer orders wherein while the set point is not reached, not shipping the goods, and when the set pint is reached, shipping the goods.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the arrangement of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention. Obviously, such equivalent methods and systems may be implemented using any of a variety of technologies and platforms including software, hardware, middleware, networks, virtual networks, distributed networks, telephonic networks, wireless networks, wired networks, satellite networks, cable networks, viral networks, applications, applets, and pieces of code running on processors of any and all kinds, including human processors, biological processors, nano-processors, and machine processors.

### BRIEF DESCRIPTION OF THE DRAWINGS

The present disclosure may be better understood and its numerous features and advantages made apparent to those skilled in the art by referencing the accompanying drawings.

FIG. 1 is a flow chart of an e-commerce method employing accumulative assembly of orders initiated by a seller in accordance with the invention;

FIG. 2A is a flow chart of an e-commerce method employing accumulative assembly of orders initiated by a buyer or buyers in accordance with the invention;

FIG. 3 shows exemplary accumulators implemented to track the accumulative assembly of orders in accordance with the invention;

FIG. 4 is a graphical representation of a status indicator in accordance with the invention;

FIG. 5 shows exemplary accumulators having different prices associated with the same goods in accordance with the invention; and

FIG. 6 is an exemplary webpage of a website implementing and displaying features of the e-commerce method in accordance with the invention.

### DETAILED DESCRIPTION OF THE INVENTION

To enable retail buyers to buy goods at prices closer to, or at wholesale prices, a system and method in accordance with the invention employs an accumulator that tracks the number of orders placed by buyers. An accumulator may be initiated by either a seller of goods or by a buyer of goods with contacts with a seller or sellers (or by sellers or goods and buyers with contacts with a seller or sellers of goods). When the accumulator is initiated, a set point is set based upon a cost effective or scale effective quantity of the goods being sold. When the set point is reached, the goods are shipped by the seller or sellers. Buyers may participate in the accumulator by placing orders over the Internet.

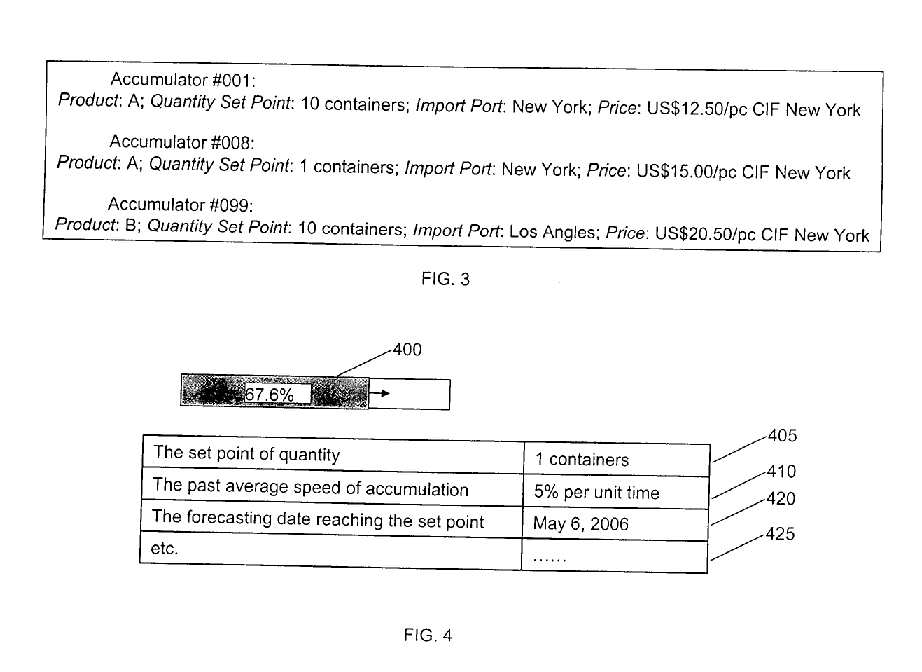

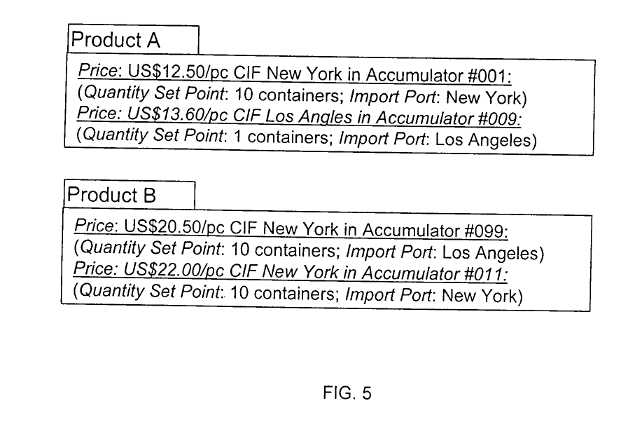

A plurality of accumulators may be initiated and displayed on a website to facilitate both seller and buyer participation. Each accumulator may reflect the goods to be shipped, the amount of the goods to be shipped, the time within which the goods will be shipped, the shipping port and other conditions relevant to the buying, selling and shipping of goods. As shown in FIG. 3, accumulator #001 relates to product A having a set point of 10 containers imported into New York at a price of US$12.5/pc CIF New York. Accumulator #008, which relates to the same product A, has a quantity set point of 1 container imported into New York at a price of US$15/pc CIF New York. Thus accumulators #001 and #008 relate to the same product A, but have different set points and different prices per piece due to the different set points. Accumulator #099 relates to product B having a set point of 10 containers imported into Los Angeles at a price of US$20.5/pc CIF New York. Differences in price may also be affected by the shipping destination as shown in FIG. 5 and more particularly with regard to accumulators #008 and #009, it being cheaper for the seller to ship to Los Angeles (reflected in accumulator #009) than to ship to New York (reflected in accumulator #008. Comparing accumulators #099 and #098, it is also cheaper for the seller to ship to Los Angeles than to ship to New York.

Each accumulator is operable to accumulatively assemble orders from buyers until the set point is reached. Software running on a conventional server machine hosting the website may keep track of orders received and orders canceled and provide a visual representation of the status of each accumulator. One such status indicator 400 is shown in FIG. 4. Status indicator 400 indicates the percentage of the set point reached. Other information relevant to the accumulator may also be provided to the buyer such as the set point quantity 405, past average rate of accumulation 410, the forecasted date of reaching the set point 420 and other conditions and parameters 425 easily within the knowledge of one skilled in the art. Conditions and parameters 425 will not be further described so as not to distract and obscure the inventive e-commerce system and method disclosed, these conditions and parameters 425 being within the skill of the ordinary artisan.

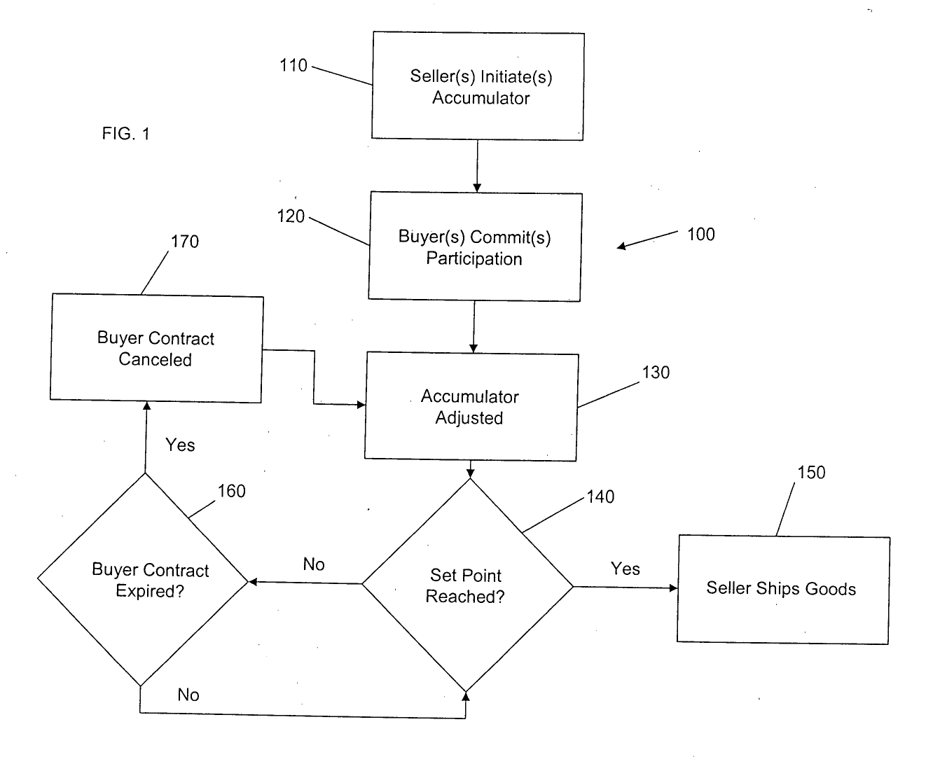

With reference to FIG. 1, a method 100 in accordance with the invention by which a seller or sellers of goods initiates an accumulator is shown. In a step 110 the seller or sellers initiate(s) an accumulator and identifies the goods being sold, the set point (quantity of goods being sold), the shipping date, shipping port and other conditions. Buyers wishing to purchase the goods being sold commit to participating in the accumulator in a step 120. Buyers may commit to participating by signing a contract with the seller or sellers or an agent(s) of the seller(s). The contract may limit the buyer's participation to a certain time period after which the buyer may cancel the contract. Other terms and conditions, not enumerated here, may also be included the contract.

Upon a buyer committing to the accumulator, the accumulator is adjusted in a step 130. In a step 140 it is determined if the set point has been reached. If the set point has been reached, the goods are shipped in a step 150. Otherwise, it is determined in a step 160 if the buyer's contract has expired. If the buyer's contract has not expired, the method returns to step 140. Otherwise the buyer's contract is canceled in a step 170. As buyers commit to participating in the accumulator in step 120, the set point may be reached. While the set point is not reached, the goods are not shipped. The execution of loop comprising step 140 and step 160 may be time delayed and run periodically.

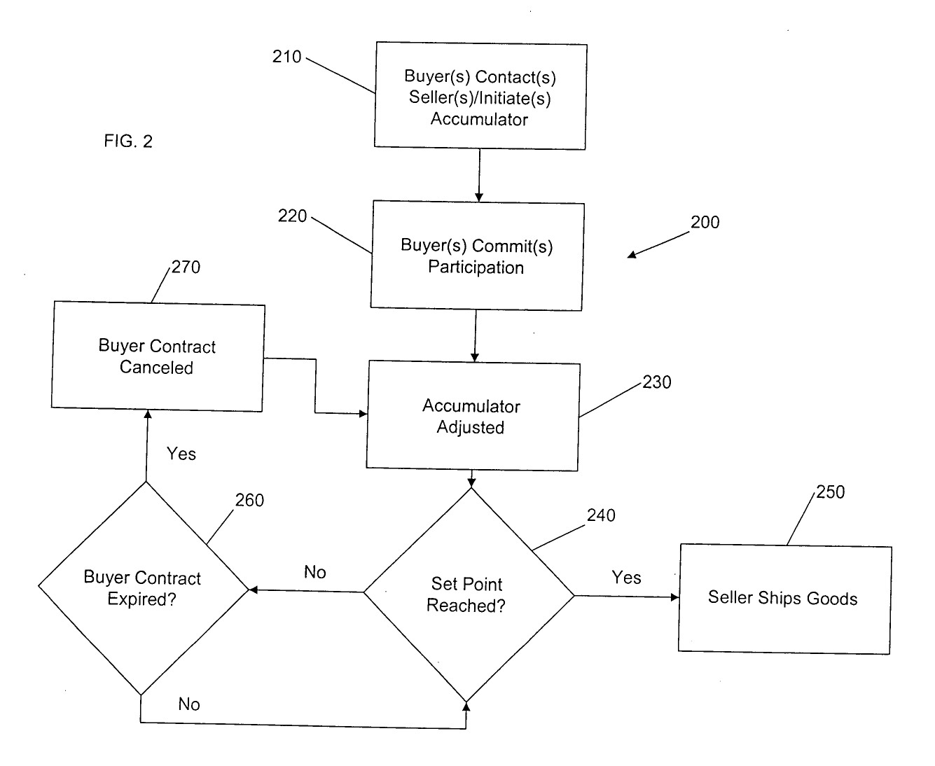

In an alternative embodiment of the invention, a buyer or group of buyers may contact a seller and initiate an accumulator in a step 210 of a method 200 as shown in FIG. 2. Buyers wishing to purchase the goods being sold commit to participating in the accumulator in a step 220. Buyers may commit to participating by signing a contract with the seller or an agent of the seller. The contract may limit the buyer's participation to a certain time period after which the buyer may cancel the contract. Other terms and conditions, not enumerated here, may also comprise the contract.

Upon a buyer committing to the accumulator, the accumulator is adjusted in a step 230. In a step 240 it is determined if the set point has been reached. If the set point has been reached, the goods are shipped in a step 250. Otherwise, it is determined in a step 260 if the buyer's contract has expired. If the buyer's contract has not expired, the method returns to step 240. Otherwise the buyer's contract is canceled in a step 270. As buyers commit to participating in the accumulator in step 220, the set point may be reached. While the set point is not reached, the goods are not shipped. The execution of loop comprising step 240 and step 260 may be time delayed and run periodically.

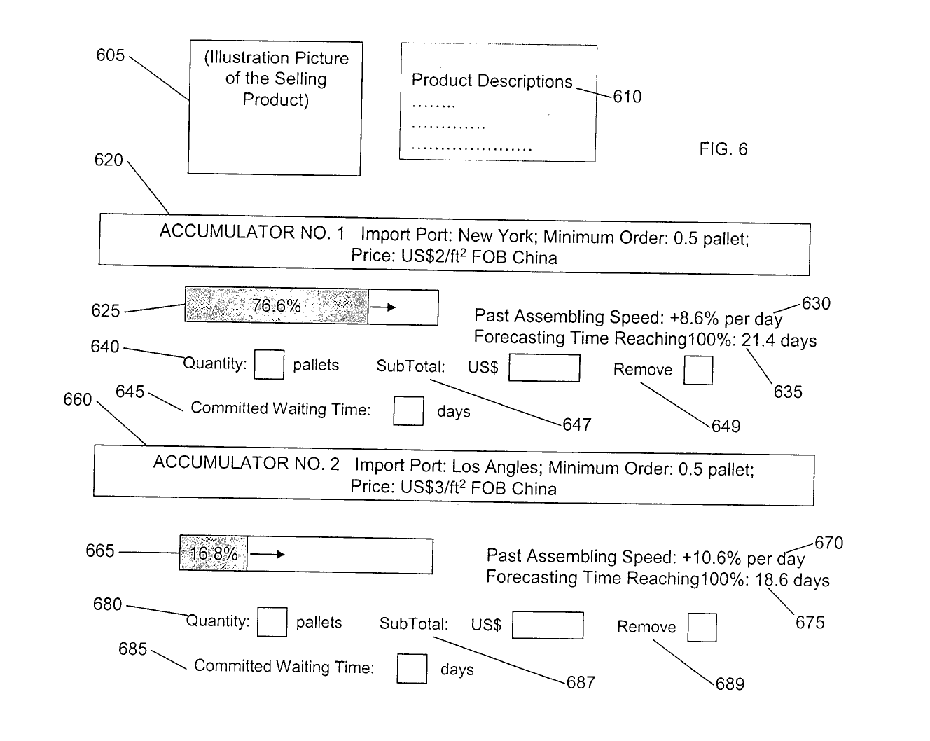

With reference to FIG. 6, an exemplary website may include an image 605 of the goods being sold together with descriptions 610 of the goods. Two accumulators 620 and 660 may be displayed to prospective buyers. Accumulator 620 may include the import port (New York), a minimum order amount (0.5 pallets) and a price (US$2/ft² FOB China). An accumulator status indicator 625 indicates that the accumulator is 76.6% toward the set point. Additional information may be provided to prospective buyers including the rate at which the accumulator is assembling buyer orders 630 and the forecasted time of reaching the set point 635. The exemplary website further includes a means by which the prospective buyer may order a quantity of goods 640 and an indication of the amount of time 645 buyer wishes to participate in the accumulator 620. The system and method of the invention may interactively provide to the buyer a sub total price 647 computed based upon the buyer information. A means for the buyer to be removed from his contractual obligations may be provided and displayed to the buyer at 649.

Accumulator 665 may include the import port (Los Angeles), a minimum order amount (0.5 pallets) and a price (US$3/ft² FOB China). An accumulator status indicator 665 indicates that the accumulator is 16.8% toward the set point. Additional information may be provided to prospective buyers including the rate at which the accumulator is assembling buyer orders 670 and the forecasted time of reaching the set point 675. The exemplary website further includes a means by which the prospective buyer may order a quantity of goods 680 and an indication of the amount of time 685 buyer wishes to participate in the accumulator 660. The system and method of the invention may also interactively provide to the buyer a sub total price 687 computed based upon the buyer information. A means for the buyer to be removed from his contractual obligations may be provided and displayed to the buyer at 689.

The foregoing description of the embodiments of the invention has been presented for the purposes of illustration and description. It is not intended to be exhaustive or to limit the invention to the precise form disclosed. Many modifications and variations are possible in light of the above teaching. For example, each accumulator may include, and keep track of, more than one product. Accumulator design is limited only by the creativity of the designer and is encompassed by the appended claims and their equivalents. It is intended that the scope of the invention be limited not by this detailed description, but rather by the claims appended hereto and their equivalents.

We claim:

1. A method of selling goods comprising:
initiating an accumulator having a set point, the set point reflecting an amount of goods to be shipped, the accumulator keeping track of buyer orders;
soliciting buyer orders; and
while the set point is not reached, not shipping the goods, and when the set pint is reached, shipping the goods.

2. The method of selling goods of claim 1, wherein the initiating step is performed by at least one seller.

3. The method of selling goods of claim 1, wherein the initiating step is performed by at least one buyer.

4. The method of selling goods of claim 1, wherein the amount of goods may be fungible goods.

5. The method of selling goods of claim 1, wherein the amount of goods may be non-fungible goods.

6. The method of selling goods of claim 1, wherein the accumulator is implemented in a machine.

7. A system of selling goods comprising:
an accumulator having a set point, the set point reflecting an amount of goods to be shipped, the accumulator keeping track of buyer orders and being implemented in a machine; and
a means for soliciting buyer orders wherein while the set point is not reached, not shipping the goods, and when the set pint is reached, shipping the goods.

8. The system of selling goods of claim 7, wherein the accumulator is accessed by at least one seller and at least one buyer by means of a system web presence.

9. The system of selling goods of claim 7, further comprising a means for adjusting the accumulator to reflect buyer commitments to terms of a commitment contract reflected in the accumulator.

10. The system of selling goods of claim 7, further comprising a means for determining when the set point is reached.

11. The system of selling goods of claim 7, further comprising a means for the at least one buyer to cancel a commitment contract.

12. The system of selling goods of claim 7, further comprising a user interface accessible over a network, the user interface providing buyer and seller access to the accumulator and graphical representations thereof.

13. A machine executable sequence of process steps for selling goods comprising:
a code segment operable to instruct a machine on a network to instantiate an accumulator having a set point, the set point reflecting an amount of goods to be shipped, the accumulator keeping track of buyer orders and being implemented in the machine; and
a code segment operable to instruct the machine on the network to instantiate a means for soliciting buyer orders wherein while the set point is not reached, not shipping the goods, and when the set pint is reached, shipping the goods.

14. The machine executable sequence of process steps of claim 13, wherein the accumulator is accessed by at least one seller and at least one buyer by means of a system web presence.

15. The machine executable sequence of process steps of claim 13, further comprising a code segment operable to instantiate a means for adjusting the accumulator to reflect buyer commitments to terms of a commitment contract reflected in the accumulator.

16. The machine executable sequence of process steps of claim 13, further comprising a code segment operable to instantiate a means for determining when the set point is reached.

17. The machine executable sequence of process steps of claim 13, further comprising a code segment operable to instantiate a means for the at least one buyer to cancel a commitment contract.

18. The machine executable sequence of process steps of claim 13, further comprising a code segment operable to instantiate a user interface accessible over a network, the user interface providing the at least one buyer and the at least one seller access to the accumulator and graphical representations thereof.

19. The machine executable sequence of process steps of claim 18, further comprising a code segment operable to instantiate a plurality of accumulators and the user interface displaying the plurality of accumulators.

20. The machine executable sequence of process steps of claim 18, wherein the user interface displays a plurality of data and criteria related to each of a plurality of accumulators.
